(19) United States
(12) Patent Application Publication
(10) Pub. No.: US 2007/0227558 A1
(43) Pub. Date: Oct. 4, 2007

(54) Vehicle Washing System and Method for Washing a Vehicle

(76) Inventor: Steven Andrew Chase, Denver, CO (US)

Correspondence Address: A PATENT LAWYER CORP, PC;R WILLIAM GRAHAM, 22 S ST CLAIR ST, DAYTON, OH, 45402, US

(21) Appl. No.: 11/277,846

(22) Filed: Mar. 29, 2006

(51) Int. Cl. B08B 7/04; B08B 3/00; B08B 3/12

(52) U.S. Cl. 134/18; 134/123; 134/172; 134/198; 134/34

(57) ABSTRACT

A vehicle washing system for cleaning a vehicle includes a track operably disposed at a washing site, a first generally U-shaped gantry operably disposed on the track for moving back and forth along the track and a second generally U-shaped gantry operably disposed on the track for moving back and forth along the track, and wherein each gantry is equipped to move generally only about a respective half of a predetermined profiled area of the vehicle when positioned adjacent to the track. The system further includes an RFID device to enable quick profiling of the vehicle.

### BACKGROUND OF THE INVENTION

The present invention is directed to vehicle washing system and method for washing a vehicle.

Vehicle wash systems can be broken down into three general groups: self-service washes, roll over washes, and conveyor washes. Self-service washes include wash equipment disposed in open bays. Roll over washes include a moving gantry equipped with wash equipment that travels on tracks on a floor or building walls and moves about a stationary vehicle applying soaps, cleaners, waxes and rinses. Tunnel or conveyor washes use push or pull equipment to move a vehicle through wash equipment disposed within the tunnel.

The car wash industry is continuously improving on the state of the art and need for improving the manner and cost of the washing system. There remains a need to improve speed, water usage, control, cost, and dependability of vehicle washing systems for various vehicles.

The inventor of the instant invention provided improvements over the art by providing a nozzle assembly that rotated about two axii to provide exemplary cleaning. This system, however, has yet to meet with significant commercial success.

There remains a need to improve upon the existing vehicle washing systems. The present invention thus improves upon the art by increasing various aspects of cleaning ability such as speed, water usage, control, cost, and dependability.

### SUMMARY OF THE INVENTION

It is an object to improve a vehicle wash system.

It is another object to improve the method for washing a vehicle.

It is still another object to improve the speed of a vehicle washing system.

It is another object to improve control of a vehicle washing system.

It is yet another object to reduce the cost of a vehicle washing system.

It is another object to minimize water usage in a vehicle washing system.

It is a further object to improve dependability of a vehicle washing system.

Accordingly, one embodiment is directed to a vehicle washing system for cleaning a vehicle which includes a track operably disposed at a washing site, a first generally U-shaped gantry operably disposed on the track for moving back and forth along the track and a second generally U-shaped gantry operably disposed on the track for moving back and forth along the track, and wherein each gantry is equipped to move generally only about a respective half of a predetermined profiled area of the vehicle when positioned adjacent to the track. In one aspect, the washing system further includes an ultra high molecular weight (UHMW) polyethylene track on which the gantries are adapted to move via a set of UHMW polyethylene wheels. Each gantry has an upper generally horizontal portion interconnecting two generally vertical side portions, wherein each portion includes a washing head having a plurality of nozzle assemblies each having a nozzle for dispensing a fluid. In a preferred embodiment, each washing head can be set at an angle to direct fluid generally inwardly toward the respective half of the predetermined profiled area of the vehicle, wherein the washing heads are operably connected to a rotator mechanism for rotating the washing heads generally only about a single axis with respect to the connected gantry throughout a washing cycle.

In another aspect, the system includes a vehicle profiling device which includes an RFID (radio frequency identification) antenna operably connected to a computer based device for a receiving data signal from an RFID device operably disposed on a vehicle having a microchip embedded within it which carries vehicle identification information data.

The computer based device uses the data in aiding to determine the vehicle's profile. Additionally, a secondary measurement device for determining a vehicle height, and/or a vehicle width can be employed to further aid in determining the vehicle's profile. A distance measurement device for measuring a distance each gantry moves along the track is provided.

In a preferred embodiment, each side portion of each gantry can include a plurality of washing heads thereby defining upper and lower washing heads on the side portions. While not necessary to the invention due to increased expense, it is contemplated that washing heads, such as lower washing heads can be equipped with additional rotator mechanisms to rotate about two axii to provide cleaning of wheels, for example.

Each washing head is operably connected to one or more fluid supply sources to permit dispensing thereof through each nozzle assembly. Each nozzle can preferably be equipped to deliver a stream of fluid. With the washing head and in turn nozzles directed at the angle, a plurality of streams of fluid hit the vehicle's surface in a manner to create a scatter pattern impinging the dirty surface of the vehicle.

The computer based device is equipped to control the fluid flow to the washing heads as well as the rotation of the heads to form a spray pattern. The rotator mechanism can be a stepper motor, an AC motor, a servo motor, an air-operated rotation device or the like.

The present invention includes a method having the steps of providing a first gantry at a first end of a vehicle which is equipped to move generally about a first half of a predetermined profiled area of said vehicle having a washing head connected thereto for dispensing a fluid an angle to direct fluid generally inwardly toward the respective half of the predetermined profiled area of the vehicle, providing a second gantry at a second end of a vehicle which is equipped to move generally about a second half of a predetermined profiled area of said vehicle having a washing head connected thereto for dispensing a fluid an angle to direct fluid generally inwardly toward the second half of said predetermined profiled area of the vehicle, and employing a computer based device to effect operation of the gantries and at least one of the washing heads.

The method further includes obtaining data from an RFID device on the vehicle and employing the computer based device to receive and use said data in a manner to generate a spray pattern corresponding to a profile of the vehicle. The method can further include utilizing sensors to determine the vehicle's position and size in conjunction with the data from the RFID device to generate the profile.

Additional characteristics and advantages of the present invention will be described below in conjunction with the accompanying figures. Other objects, features and advantages of the present invention will become more fully apparent from the following detailed description, the appended claims and the accompanying drawings.

### BRIEF DESCRIPTION OF THE DRAWINGS

FIG. 1 depicts a simplified perspective view of a vehicle washing system according to the present invention;

FIG. 1A depicts an enlarged view of the portion of spray pattern.

FIG. 2 depicts a side view of the system in use;

FIG. 3 depicts an illustration of a liquid spray pattern according to the present invention;

FIG. 4 depicts a portion of the system of the invention;

FIG. 5A depicts a front view of a washing head according to the present invention; and

FIG. 5B depicts a side view of a washing head according to the invention.

### DESCRIPTION OF THE SPECIFIC EMBODIMENTS

Referring now to the drawings, the vehicle washing system of the instant invention is generally designated by the numeral 10 for cleaning a vehicle V. The vehicle washing system 10 can include a gantry support framework 12 (wherein a majority of structural components can be made of a rigid material such as galvanized steel or the like) having first side 13 including a first plurality of vertical side supports 14 interconnected by a first generally horizontal beam 16 having a track 18 disposed thereon and a second side 19 including a second plurality of vertical side supports 20 interconnected by a generally horizontal beam 22 having a track 24 disposed thereon. The first side 13 and second side 19 are generally disposed in a parallel relation and interconnected at their respective ends 27 and 29, respectively, by generally horizontal transverse members 26 and 28. The gantry support framework 12 is operably disposed at a washing site W.

A first generally inverted U-shaped gantry 30 is operably disposed on the tracks 18 and 24 for moving back and forth therealong from one end 27 toward the middle of the framework 12. Similarly, a second generally inverted U-shaped gantry 32 is operably disposed on the tracks 18 and 24 for moving back and forth therealong from end 29 toward the middle of the framework 12. Each gantry 30 and 32 is equipped to move along tracks 18 and 24 generally about a respective half of a predetermined profiled area A of the vehicle V. Each gantry 30 and 32 has an upper generally horizontal portion 34 and 36, respectively. The horizontal portion 34 interconnects two generally vertical side portions 38 and 40 and horizontal portion 36 interconnects two generally vertical side portions 42 and 44. Each portion 34, 36, 38, 40, 42, and 44 includes one or more washing heads 46.

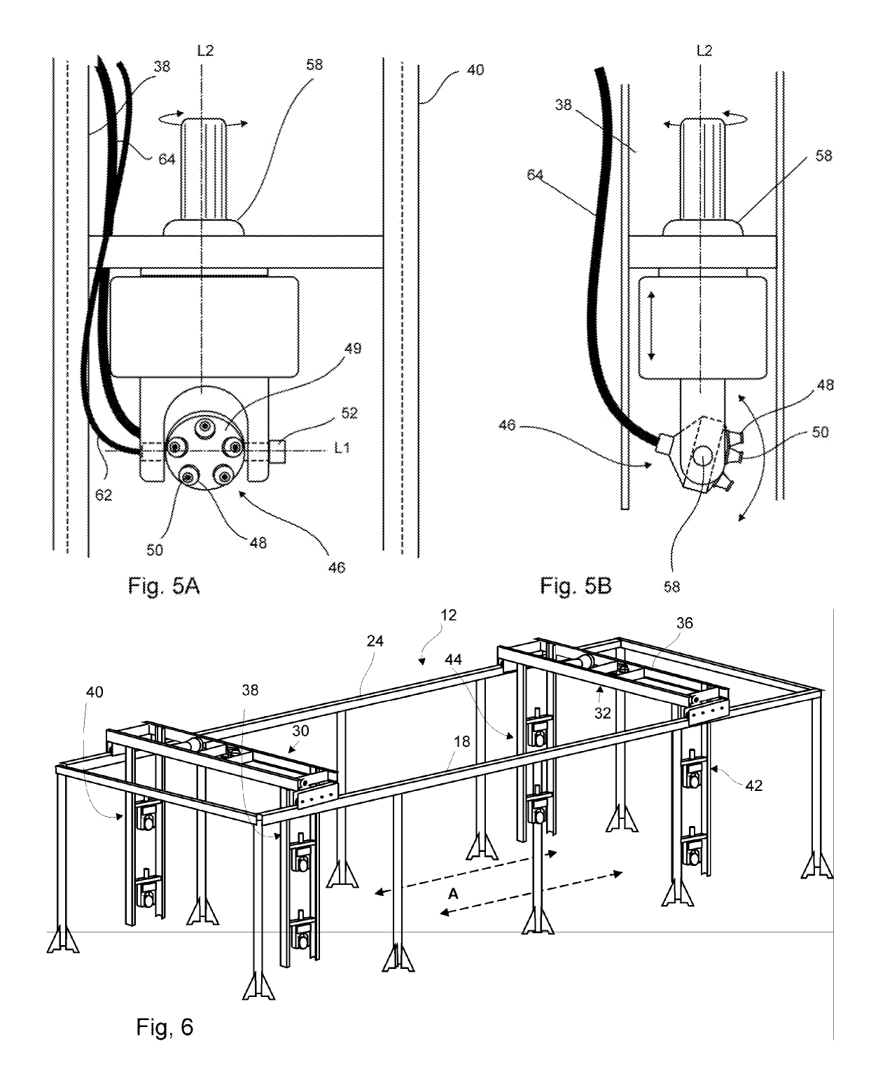

As seen in FIGS. 5A and 5B each washing head 46 has a plurality of nozzle assemblies 48 each having a nozzle 50 for dispensing a fluid. In a preferred embodiment, there are five nozzle assemblies 48 to provide a suitable spray pattern. The nozzle assemblies 48 are spaced generally equally about the periphery of a face 49 of the washing head 46. Each washing head 46 can preferably be set at a fixed angle with respect to its gantry 30, 32 to direct fluid from the nozzle 50 generally inwardly toward the respective half of the predetermined profiled area A of the vehicle V. Here, the washing heads 46 are operably connected to a rotator mechanism 52 for rotating the washing heads 46 generally about an axis L1. The rotator mechanism 52 can be a stepper motor, an AC motor, a servo motor, an air-operated rotation device or the like. By virtue of such rotation, the nozzles 50 emit a stream of fluid within a generally planar pattern.

The tracks 18 and 24 can preferably be made of an ultra high molecular weight (UHMW) polyethylene material. The gantries 30 and 32 are operably equipped with a set of UHMW polyethylene wheels 54 and 56, respectively, which carry the load of the gantries 30 and 32 and enable linear movement along the tracks 30 and 32. By providing the track 18, 24 and wheels 54, 56 in this manner, the system has been found to exhibit minimal wear during use over a repeated use.

In a preferred embodiment, side portions 38 and 40 of gantry 30 and side portions 42 and 44 of gantry 32 can include a plurality of washing heads 46 thereby defining upper washing heads 46U and lower washing heads 46L. While not necessary to the invention due to increased expense, it is contemplated that some of the washing heads 46, such as lower washing heads 46L can be equipped with an additional rotator mechanism 58 as seen in FIG. 5A to rotate about two axii to provide for alternating spray patterns thereby enabling impingement of various angled dirty surfaces, such as the case of cleaning of wheels, for example.

Each washing head 46 is operably connected to one or more fluid supply sources via hoses 60, 62 to permit dispensing fluid through each nozzle assembly 48. High pressure water feed line 60 can provide water or other fluids to nozzle assemblies 48. Additional feed line 62 can be deliver one or more variety of chemicals to one or more chemical nozzle assemblies 48.

There can be one or more chemical feed lines 62 are coupled to one or more nozzle assemblies 48. In one embodiment, chemical feed lines 62 deliver soap, wax, cleaners, rust inhibitors and the like to nozzle assemblies 48.

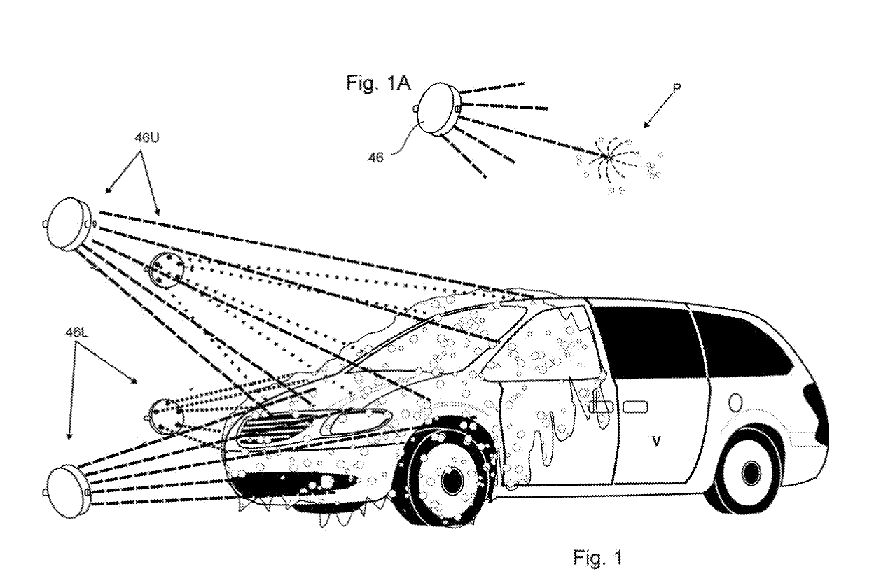

Each nozzle 50 can preferably be equipped to deliver a stream of fluid such as a zero degree nozzle. With the washing head 46 and in turn nozzles 50 directed at the inwardly facing angle as seen in FIG. 1A, a plurality of streams of fluid hit the vehicle's surface in a manner to create a scatter pattern P impinging the dirty surface of the vehicle V.

In another aspect, the system 10 includes a vehicle profiling device 70 which includes an RFID (radio frequency identification) receiver 72 operably connected to a computer based device 74 in a manner for receiving data from an RFID antenna device 76 operably disposed on the vehicle V. The RFID device 76 has a microchip embedded within it which carries vehicle identification information data. The computer based device 70 uses the vehicle identification data in aiding to determine the vehicle's profile. Additionally, a secondary measurement device for determining a vehicle height, and/or a vehicle width can be employed to further aid in determining the vehicle's profile. A distance measurement device for measuring a distance each gantry 30, 32 moves along the track 18, 24 is provided. The computer based device 70 is equipped to control the fluid flow and type of fluid to the washing heads 46 as well as the rotation of the washing heads 46 to form a spray pattern corresponding to the vehicle's profile.

As previously described, the rotator mechanism 52 can be a step motor which include a wide range of step measuring devices or rotary devices capable of rotating the washing head 46. The rotator mechanism 52 can include a stepper motor, an AC motor, a servo motor, air operated rotary devices including pneumatic devices, a belt drive, chain, straps and other devices capable of transferring rotational movement of rotator mechanism 52 to the support which is coupled to washing head 46.

Rotator mechanism 52 operates to rotate or tilt the washing head 46 about a first rotational axis L1 as shown in FIG. 5A and is equipped with about one hundred and eighty degree (180 degree) range of rotation. With single axis rotation, feed lines 60, 62 do not tend to get wrapped around supports for the washing heads 46. Further, a bendable cage 68 (which can include chain link design) is employed through which the feed lines 60 and 62 can pass to prevent unwanted wrapping around the support framework 12. It is appreciated that the number of washing heads 46 can be such to accommodate a variety of sized and shaped vehicles. Since in the instant invention, the washing heads 46 are primarily intended to only be in a single axis of rotation, winding or twisting of water lines 60 and chemical feed lines 62 are less likely.

While not necessary and that it increases cost, additional rotator mechanisms can be added to provide panning and tilting in a step like pattern to enhance washing certain vehicle features, such as wheels and wheel wells. In such case, an additional rotator mechanism 58 can be added to the system to rotate the washing head 46L about a second rotational axis L2. This enables a range of rotation of about up to about 360 degrees.

In one embodiment, nozzles 50 are zero degree (0 degree) nozzles. Zero degree nozzles operate by projecting water or other fluid under high pressure and have a nozzle shape which generally directs the water in a tight narrow beam having about 0 degree dispersion. One advantage of zero degree nozzles is the high impingement of water dispensed from such nozzles several feet from the nozzle itself. For example, fluid dispensed from a zero degree nozzle still has about 75% of its pressure at a distance of about six feet from the nozzle. Use of a zero degree nozzle or the like is important for an effective operation of the instant invention. In the case of applying chemicals it is believed such nozzles provide a more effective impingement of the dirty surface, although it is recognized that rinsing agents and wax solutions or other chemicals can use wider angle dispersion nozzles, such as a 5 degree nozzle to provide wider coverage of the chemicals over the vehicle being washed.

It is appreciated that more than one water feed source may be used to supply water or other fluid to washing head 46. Water is ejected under high pressure from the nozzles 50 at pressures which range from about 600 pounds per square inch (PSI) to about 1,200 PSI for a vehicle wash system, preferably about 1,000 PSI. Other pressures also may be used within the scope of the present invention.

The framework support 12 and gantries 30 and 32 can be made of steel, or other suitably material, wherein certain components, such as nozzle assembly 48 can be made of stainless steel. The washing system 10 is configured such that nozzles 50 can operate simultaneously or in a predetermined order. For example, high pressure water delivery may occur through all nozzles 50 at the same time that wax, soap or other chemicals are provided through other nozzles 50.

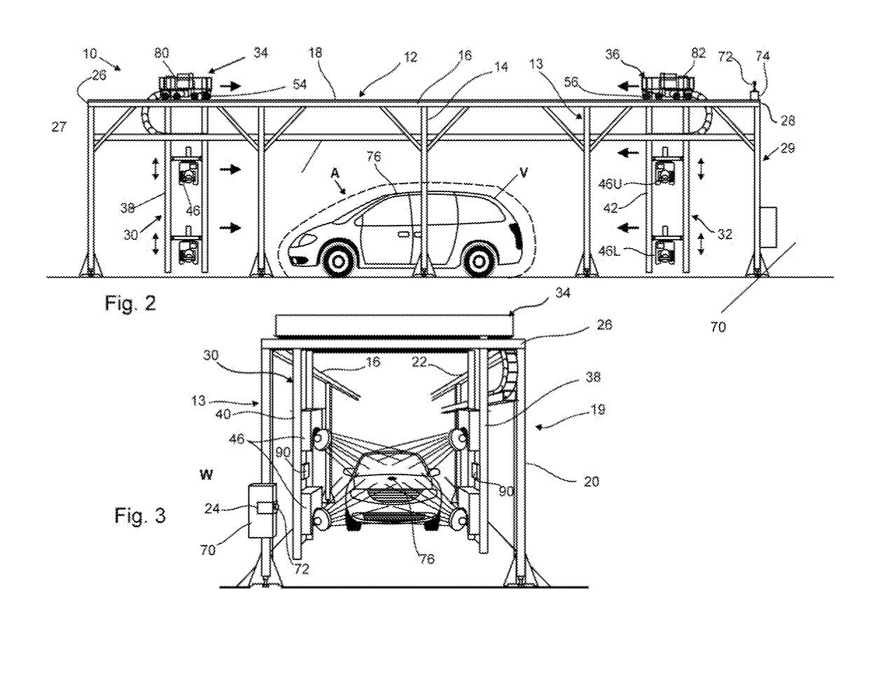

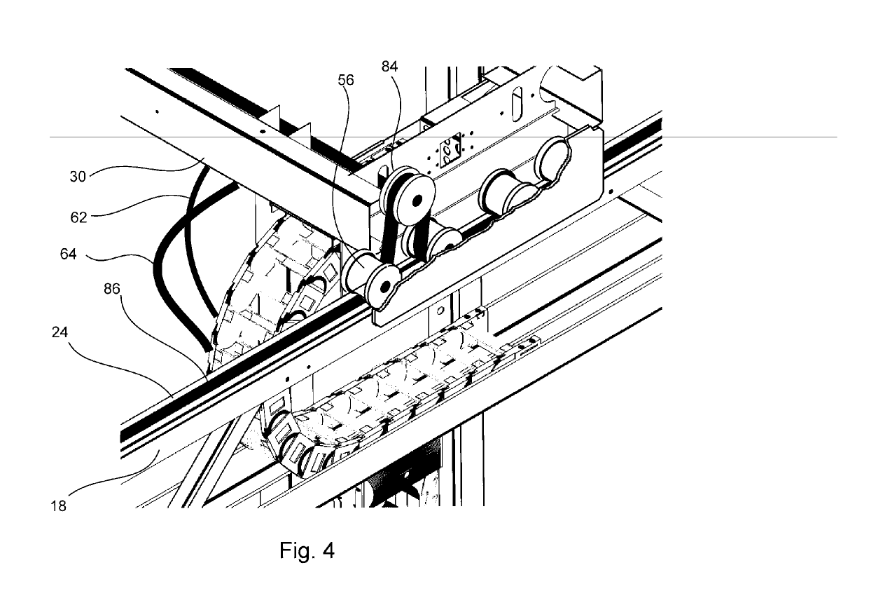

The vehicle washing system can be of a size to accommodate a variety of vehicles size to permit the passage of most personal or recreational vehicles thereunder. As shown in FIG. 2 the vehicle washing system 10 is designed to permit vehicle V to remain generally stationary during a cleaning procedure. The gantries 30 and 32 travel along tracks 18 and 24 by way of a drive motor system 80 and 82 which are operably connected to one or more wheels 54 and 56, respectively. A belt 84 is operably disposed about wheels 54 and seats within a groove 86 in track 18. Likewise, belt 88 is operably disposed about wheels 56 and seats within a groove 90 in track 18. The wheels 54 and 56 as well as the tracks 18 and 24 can preferably be made of an ultra high molecular weight (UHMW) polyethylene. This not only aids in the operation, but also in the wear of the components as the bear on one another. The drive motors 80 and 82 are operably connected to the computer based device 70 to permit controlled travel of gantries 30 and 32 on the tracks 18 and 24. It is contemplated that the system 10 can be modified for other application.

Prior to the vehicle V entering through the gantries 30 and 32, the computer based device 70 has predetermined the vehicle profile via the RFID device 72. Additionally and or optionally, as the vehicle V enters the system 10, additional sensors (such as ultrasonic, electronic eye or camera) can be used to size profile of aspects of the vehicle V as a cross check.

The wash procedure can preferably begin with each gantry 30 and 32 near ends 27 and 29 of framework support 12 and the washing heads 46 directed inwardly toward the profiled area A in which the vehicle V resides. The front portion of vehicle V can be soaked with cleaning agent by the two uppermost washing heads 46U positioned near upper portion of gantries 30 and 32 as well as washing head 46 on horizontal portions 34 and 36. The present invention deviates from prior systems in that a particularly efficient cleaning spray pattern is achieved by using a preset washing head angle and a single rotator mechanism to rotate about the axis L1 to enable panning back and forth motion as gantry 30 or 32 moves inwardly or outwardly about the respective half of the predetermined area A to clean the vehicle V in an improved manner.

Due the stream-like dispensing by nozzles 50, there is a relatively minimal dispersion though the vehicle V may be several feet away from nozzles 50. The vehicle washing system 10 takes advantage of the single-axis panning capabilities by virtue of the movable dual gantries 30 and 32 to achieve a high quality cleaning. The degree range of panning is dictated based upon the profile of the vehicle V. By providing the dual gantry system 12 as shown and described, the washing heads 46 can aim at most any profiled point of vehicle V without the need of a second axis of rotation. This is a cost savings of this aspect of the prior system. Further, the dual gantries 30 and 32 enable washing to be completed in about half the time as prior systems which results in increased revenues through the current system.

The water trajectory profile and impingement on the vehicle V is determined by the computer based device 70. For example, the computer based device 70 can create a wash pattern based on the profile as well as such conditions as temperature, season such as wherein bugs or salt are a particular problem on windshields, side mirrors, lights, front and rear spoilers, or on hard to clean areas like tires and wheels, wheel wells, and the like.

Nozzles 50 can be configured to dispense soap or other liquids during a washing process. Multiple different chemicals, having the same or different appearance or color, can be dispensed sequentially, in series or at the same time.

As recognized by the inventor in his prior invention, prior art washing systems use indiscriminate spraying of water, soap and other fluids regardless of the size of the vehicle being washed. His prior invention used a vehicle sizing mechanism primarily to arrive at the size of the vehicle. However, this system can lead to inaccurate profiling in the case where the vehicle V has been modified, such as when a utility van has been modified to hold a ladder on top of its roof, for example. The RFID device 72 enables an additional level of profiling to provide an initial manufacturer's specification profile of the vehicle and additional sensors 90 can be employed to supply signals corresponding to additional sensed data and based upon learned pattern recognition techniques, apply correction to properly profile the vehicle to be washed. The additional sensors can be used for identifying anomalies in the vehicle profile and may include optic eyes, proximity sensors, laser-type sensors, ultrasonic sensors, photoelectric eyes, and the like. Such sensors 90 can be positioned in pairs, with sensors coupled to vertical side supports 14 and 20. Such sensors can also be used to operate as a check of the vehicle profile, or as a backup in the event of the RFID information not being picked up. Preferably, these sensors can be used to detect variances in height or width of the vehicle specification profile using bounce back technology to compare against the original vehicle manufacture's profile information. Bounce back technology can employ ultrasonic sensors, for example, which includes an emitter/receiver for picking up deflected signals from its emitted signals, wherein the computer aided device 70 uses these signals to calculate a particular profile. Thus, in the case where running boards are added for example, the spray pattern can be adjusted according. However, where a ladder is added to the top, the computer based device 70 is equipped with a data profile which maintains the spray pattern on the vehicle roof as opposed to areas above the known roof line, i.e., a ladder detection may not cause an alteration in the spray pattern. The gantry 30 can include one or more sensors located in the horizontal portion 34. Sensors may be similar sonar-proximity sensors to detect the width of vehicle or calculate the reflection of the transmitted ultrasonic signal from either the floor of the washing facility or from the vehicle itself.

As the gantries 30 and 32 travel along the tracks 18 and 24 during the washing procedure, the computer based device 70 is able to direct the system 10 to provide an appropriate spray pattern to impinge the dirty surface of the vehicle V and not spray past or over the vehicle. While certain aspects of the present are directed to dual moving gantries, it will be appreciated by those skilled in the art that other aspects of the present invention will find use for the stationary gantry systems as well. For example, the RFID device can be employed in such systems.

While the present invention has been disclosed in connection with the preferred embodiments thereof, it should be understood that other embodiments may fall within the spirit and scope of the invention, as defined by the following claims.

What is claimed is:

1. A vehicle washing system for cleaning a vehicle at a washing site, which includes: a track operably disposed at the washing site; a first generally U-shaped gantry operably connected to said track for moving back and forth along said track; a second generally U-shaped gantry operably connected to said track for moving back and forth along said track; wherein each said gantry is equipped to move generally about a respective half of a predetermined profiled area of said vehicle when positioned adjacent to said track, each said gantry includes a washing head connected thereto for dispensing a fluid an angle to direct fluid generally inwardly toward the respective half of said predetermined profiled area of the vehicle, wherein each said washing head is operably connected to a rotator mechanism for rotating said washing heads generally only about a single axis with respect to said connected gantry throughout a washing cycle, and each said washing head is operably connected to at least one fluid supply sources to permit dispensing therethrough.

2. The vehicle washing system of claim 1, wherein each said gantry has an upper generally horizontal portion interconnecting two generally vertical side portions, wherein each portion includes a washing head connected thereto having a plurality of nozzle assemblies each having a nozzle for dispensing a fluid and each washing head is set at an angle to direct fluid generally inwardly toward said respective half of said predetermined profiled area of the vehicle, wherein each washing head is operably connected to a rotator mechanism for rotating said washing heads generally only about a single axis with respect to said connected gantry throughout a washing cycle.

3. The vehicle washing system of claim 1, wherein each said gantry includes a set of plastic wheels and said track is comprised of like plastic material, where said gantries are adapted to move on said track via a set of plastic wheels.

4. The vehicle washing system of claim 1, which further includes a vehicle profiling device having an RFID antenna operably connected to a computer based device for receiving data from an RFID device operably disposed on said vehicle having vehicle identification information data for determining the vehicle profile, wherein said computer based device uses said data in determining a vehicle profile and operates said system in accordance with said profile.

5. The vehicle washing system of claim 4, which further includes a distance measurement device for measuring a distance each said gantry moves along said track.

6. The vehicle washing system of claim 1, which further includes a distance measurement device for measuring a distance each said gantry moves along said track.

7. The vehicle washing system of claim 4, which further a secondary measurement device for determining one of height and width to further aid in determining the vehicle's profile.

8. The vehicle washing system of claim 1, which further a measurement device for determining one of height and width to further aid in determining the vehicle's profile.

9. The vehicle washing system of claim 2, wherein each said side portion of each said gantry includes a plurality of washing heads thereby defining upper and lower washing heads on said side portions.

10. The vehicle washing system of claim 9, wherein said lower washing heads are equipped with additional rotator mechanisms to enable said washing heads to rotate about two axii.

11. The vehicle washing system of claim 1, wherein each said washing head includes a nozzle equipped to deliver a stream of fluid.

12. The vehicle washing system of claim 11, wherein said washing head and in turn nozzles directed at said angle such that a plurality of streams of fluid hit the vehicle's surface in a manner to create a scatter pattern impinging a dirty surface of the vehicle.

13. The vehicle washing system of claim 1, which includes a computer based device equipped to control movement of said gantries, the fluid flow to said washing heads as well as the rotation of said washing heads.

14. A vehicle washing system, which includes a computer operated gantry equipped to spray fluid in a manner for washing a vehicle, and an RFID device operably connected to said computer operated gantry for enabling vehicle profiling.

15. The vehicle washing system of claim 14, which includes a secondary vehicle measuring device for aiding in determining anomalies in the vehicle's profile.

16. A method of washing a vehicle, including the steps of: providing a first gantry at a first end of a vehicle which is equipped to move generally about a first half of a predetermined profiled area of said vehicle having a washing head connected thereto for dispensing a fluid an angle to direct fluid generally inwardly toward the respective half of said predetermined profiled area of the vehicle, providing a second gantry at a second end of a vehicle which is equipped to move generally about a second half of a predetermined profiled area of said vehicle having a washing head connected thereto for dispensing a fluid an angle to direct fluid generally inwardly toward said second half of said predetermined profiled area of the vehicle, and employing a computer based device to effect operation of said gantries and at least one of said washing heads.

17. The method of claim 16, which further includes obtaining data from an RFID device on the vehicle and employing said computer based device to receive and use said data in a manner to generate a spray pattern corresponding to a profile of the vehicle.

18. The method of claim 16, which further includes utilizing sensors to determine the vehicle's position and size in conjunction with the data from the RFID device to generate the profile.
